(19) United States
(12) Patent Application Publication
(10) Pub. No.: US 2003/0029911 A1
(43) Pub. Date: Feb. 13, 2003

(54) System and method for converting digital content

(75) Inventor: Fumihiko Kitayama, Sagamihara-shi (JP)

Correspondence Address: IBM CORPORATION, INTELLECTUAL PROPERTY LAW DEPT., P.O. BOX 218, YORKTOWN HEIGHTS, NY, 10598, US

(73) Assignee: International Business Machines Corporations

(21) Appl. No.: 10/206,674

(22) Filed: Jul. 26, 2002

(30) Foreign Application Priority Data
Jul. 26, 2001 (JP) 226833

(51) Int. Cl. G07G 1/00

(52) U.S. Cl. 235/100

(57) ABSTRACT

Disclosed is a system for converting digital contents having a tree structure (e.g. web contents) and described in HTML or other markup languages into a format (e.g. WML) suitable for transmission to a portable terminal which has a limited memory capacity. In the digital content, annotation information is appended to each node of the content. The content is divided into “cards”, which are units for displaying the content on the terminal device, based on this annotation information. The system receives a user request and acquires information regarding a memory capacity of a receiving buffer in the terminal device. The system generate a “deck”, which is a unit for transmitting the content to the terminal device at a time, by collecting cards based on a predetermined rule so that a data size is within the memory capacity of the receiving buffer in the terminal device.

### BACKGROUND OF THE INVENTION

1. Field of the Invention

The present invention relates to a computer system for distributing digital contents, such as web contents to a terminal device over a network, and more particularly to a server for distributing the contents described in HTML or other markup languages by converting them into a format suitable for a portable terminal such as the WML.

2. Description of the Related Art

In these days, portable or mobile information terminals (hereinafter referred to as portable terminals) such as a portable telephone or PDA (Personal Digital Assistant) having a function of making access to web contents (simply referred to as contents) on the Internet have been spread.

These portable terminals have a small display screen for displaying the contents, and a small memory capacity of receiving buffer (memory), as compared with the typical network computer terminals (desktop or notebook type personal computers, or workstations). Accordingly, a web server for transmitting the contents to the portable terminal needs to convert the contents based on the capability of such terminal.

As the contents description language suitable for the portable terminals of this kind, particularly the wireless terminals, WML (Wireless Markup Language) and HDML (Handheld Device Markup Language) are known. The contents described in these languages are constituted of a “card”, as a display unit in the portable terminal, and a “deck” composed of a plurality of cards. The contents are transmitted or received in units of decks.

Usually, the contents are described in HTML and have a tree structure. Accordingly, in order to convert the contents into a data file in WML or HDML form and transmit the contents to the portable terminal, the contents of tree structure must be divided into appropriate cards and decks.

Since the card is a physical display unit that is practically displayed on the display screen of the portable terminal, it is important that the displayed contents are easy to view and the navigation is intuitive and familiar for a user of the portable terminal.

Also, since the deck is a unit of transmitting or receiving data at a time at the portable terminal, if a number of cards can be gathered into one deck, the number of communications can be reduced to increase a communication efficiency. On the other hand, the size of one deck must be less than or equal to the memory capacity of a receiving buffer in the portable terminal to which the data is transmitted.

Herein, the size of display screen or the memory capacity of the receiving buffer in the portable terminal is often varied for each device type, whereby it is desirable that the process for converting the tree structure of contents into the structure composed of cards and decks is dynamically performed upon a request of transmission from the portable terminal.

A conventional method that is typically used to make this conversion process involves firstly converting the contents into simple texts, and separating the texts into cards for every appropriate number of characters. This method is employed, for examples, in the cases of displaying electronic mail messages and converting the contents described in HTML into the HDML file in the EZweb service (using the HDML) by KDDI Corporation.

With this method, the original contents are mechanically divided, irrespective of its meaning or context, often resulting in unnatural way of dividing. For instance, the contents are divided in the middle of a sentence or a word, or in the middle of a line on the display screen.

Since the created cards are transferred sequentially from the beginning in many cases, even when a user wants to see a part of the contents, the user is required to view the contents from the beginning, which is inconvenient in use.

A conventional technique for generating cards and decks from the contents of tree structure was disclosed in Published Unexamined Japanese Patent Application No. 2000-194612. Using the technique as described in the same publication, the contents of tree structure are divided based on specific tags, such as TABLE, IMG, FIELDSET and IFRAME, while the logical sequence of this tree structure is preserved. Also, with this technique, the inside information of the contents is classified based on the categories, such as text, image and link, and displayed using the menu and the link. Moreover, with this technique, the decks are generated within the memory capacity of receiving buffer at the portable terminal.

Another similar conventional technique is a software product “cMagic” made by Pro Five Co., LTD, in which the original HTML text is divided into cards at specific tags (<br>, <p>, <table>, <form>, etc.), thereby decreasing the cases of unnatural way of dividing.

Another conventional technique for generating cards and decks from the contents of tree structure was disclosed in Published Unexamined Japanese Patent Application No. 2000-76473. Using the technique as described in the same publication, the index information is extracted, employing the structure of contents or the specific tag information, to create an outline page, thereby reflecting the structure information of original contents to the data file after conversion.

In case of gaining access to the contents by the portable telephone, PDA or portable terminal, as described above, to cope with the constraints on the size of display screen and the memory capacity of the receiving buffer, the contents of tree structure were often converted into the data file having the structure composed of cards and decks suitable for the portable terminal in the web server. In this case, from the viewpoint of cards as display units in the portable terminal, it is required that the display contents are easy to be viewed, and the navigation is intuitive and familiar for the user of the portable terminal. Also, from the viewpoint of decks as communication units between the server and the portable terminal, it is required to gather as many cards as possible (include a lot of data) as far as the data size does not exceed the memory capacity of receiving buffer for the portable terminal.

Further, in order to reduce the number of communications of the contents and enhance the communication efficiency, it is necessary not only to gather as many cards as possible in one deck, but also to divide the contents into cards and select them to be gathered into one deck so that the occurrence of retransmission requests from the portable terminal can be reduced, based on the substance of contents or the original tree structure.

With the above simple method of converting the contents into simple texts and then dividing them into cards for every appropriate number of characters, there are some unnatural ways of dividing the contents to make the substance of card unnatural, which was inconvenient to view a part of the contents.

With the conventional technique as disclosed in the Published Unexamined Japanese Patent Application No. 2000-194612, in dividing the contents, the logical sequence of tree structure for the contents can be preserved to some extent. Also, the information contained in the contents is classified to be displayed. However, there are no special contrivances taken for the method of dividing the contents into cards, and because classifying the information contained in the contents is not based on the original data structure, it is not easy for the user of the portable terminal to use the generated contents composed of cards and decks.

Moreover, these methods depend on a specific Markup language, and lack in universality.

The conventionally known software “cMagic” is contrived to divide the original HTML texts at specific tags to reduce unnatural division, but even if the contents are partly viewed, it is necessary to view the contents in succession from the beginning, and this software is not easy to use. By designating the tags which specify the positions for dividing the HTML texts, the original HTML texts cannot be divided in the middle of the <table> tag, bringing about a new risk that the receiving buffer of the portable terminal is overflowed even with one deck when the contents are transmitted.

Further, with the conventional technique as disclosed in Published Unexamined Japanese Patent Application No. 2000-76473, in converting the contents of tree structure into cards and decks, the structure information of contents is reflected to the data file after conversion. However, its conversion rule is derived using a heuristic method, and therefore depends on the specific structure or tag information and the specific data type (e.g. data which includes valid heading tags). Accordingly, the conversion rule is difficult to apply to the general types of contents having general structures. Also, with this method, the application of algorithm is repeated till the evaluation value meets a predetermined standard (e.g. a capacity limit of the receiving buffer), whereby this method is inefficient for the web application that must process a large number of requests quickly.

### SUMMARY OF THE INVENTION

It is an object of the present invention to generate cards which are easily used for a user at a user terminal, based on the conditions of the user terminal and the substance or structure of contents, in a system where the tree-structured contents are divided into cards and decks, and transmitted.

Also, it is another object of this invention to constitute the decks dynamically by selecting an optimal or appropriate set of cards to reduce the frequent retransmission of decks, providing that the data size of one deck is within the limit capacity (number of bytes) of a receiving buffer in the user terminal.

In order to attain the above objects, the present invention provides a system (typically a server) for converting digital content, such as web content, for distribution to a user terminal which has a limited display and memory capacity, such as a portable terminal and phone. The system comprises a receiving unit for receiving a transmission request for the digital content from the terminal, and a card generating unit for dividing the digital content into a plurality of cards based on annotation information appended to each data element in the digital content. A “card” is a unit for displaying the digital content on the terminal. The digital content typically has a tree structure in which said each data element is treated as a node.

The annotation information includes 1) information for indicating if said each data element as the node is separable from a parent node and 2) information for specifying if said each data element as the node is a random access node or a sequential access node. The annotation information may be automatically appended to the digital content or may be appended by a programmer or developer by using an editing tool.

The card generating unit divides the content into said plurality of cards so that all the unseparable nodes are embedded into a card of their parent node. And also the card generating unit divides the digital content into a set of cards having a tree structure comprising a hierarchical menu of random access nodes to be accessed randomly and a series of card groups to be accessed sequentially.

The receiving unit further receives, from the user terminal, memory information on a memory capacity of a buffer in the terminal for storing the digital content. The system further comprises a deck generating unit for generating a “deck”, which is a unit for transmitting the digital content at a time between the system and the user terminal, by collecting a requested card including at least a data element requested by the terminal and a card linked to or from the requested card based on a predetermined rule, so that a transmission data size is within said memory capacity. If the requested card is a card to be accessed sequentially, the deck generating unit generates the deck by collecting a series of cards to be accessed sequentially including the requested card. If the requested card is a card to be accessed randomly, the deck generating unit generates the deck by collecting, in addition to the requested card, at least one card on a path going from the requested card to a root card in the digital content. And also, if the requested card is a card to be accessed randomly and the memory capacity of the buffer is not reached, the deck generating unit further collects descendant cards of the requested card in a breadth-first searching manner.

This invention can be grasped by a method for converting the digital content for distribution to a user terminal which has a limited display and memory capacity.

Also, this invention provides a contents editing device comprising node editing means for inputting web contents in a tree structure and associating the information indicating whether or not a self node is separable from the parent node, and the information specifying a method of presenting the information contained at the self node to each of the nodes of the web contents, based on the structure of the web contents, and storage means for storing the web contents for which the information is appended to each node.

Further, this invention can also be implemented as a program for converting the digital content for distribution to a user terminal which has a limited display and memory capacity.

### BRIEF DESCRIPTION OF THE DRAWINGS

FIG. 1 is a diagram showing an example of a system configuration for implementing an embodiment of the present invention.

FIG. 2 is a diagram typically illustrating an example of a hardware configuration of a computer suitable for implementing a content server according to the embodiment of the invention.

FIG. 3 is a block diagram showing an example of functional blocks for dividing contents according to the embodiment of the invention under the control of a CPU by the program as shown in FIG. 2.

FIG. 4 is a flowchart for explaining an example of a procedure for dividing the contents of tree structure into cards according to the embodiment of the invention.

FIG. 5 is a flowchart for explaining an example of a procedure for generating a deck by gathering cards according to the embodiment of the invention.

FIG. 6 is a diagram showing a configuration example of a network system to which the embodiment of the invention is applied.

FIG. 7 is a diagram illustrating an example of the tree-like contents with the annotation information appended at its node to present the retrieval result in the product retrieval by a web application.

FIG. 8 is a diagram showing an example of XML document having annotations as additional information embedded.

FIG. 9 is a diagram illustrating an application example of a carding algorithm of the card generation section to the contents of FIG. 7.

FIG. 10 is a diagram illustrating an application example of a deck generating algorithm of the deck generating unit to the carded contents of FIG. 9.

FIG. 11 is a view showing a sample edit screen of the contents according to the embodiment, as a display example of the screen for deciding the node to which the annotation is appended.

FIG. 12 is a view showing a sample edit screen of the contents according to the embodiment, as a display example of the screen for appending the annotation information to a desired node.

FIG. 13 is a block diagram showing another configuration example of a network system to which this embodiment of the invention is applied.

FIG. 14 is a diagram showing how to append the annotation information to the news contents described in HTML.

FIG. 15 is a diagram illustrating an example of the contents in which the XML document of FIG. 14 is carded.

FIG. 16 is a diagram showing a configuration example of a front end application developing model to which the embodiment of the invention is applied.

### DETAILED DESCRIPTION OF A PREFERRED EMBODIMENT OF THE INVENTION

The preferred embodiments of the present invention will be described below in detail with reference to the accompanying drawings.

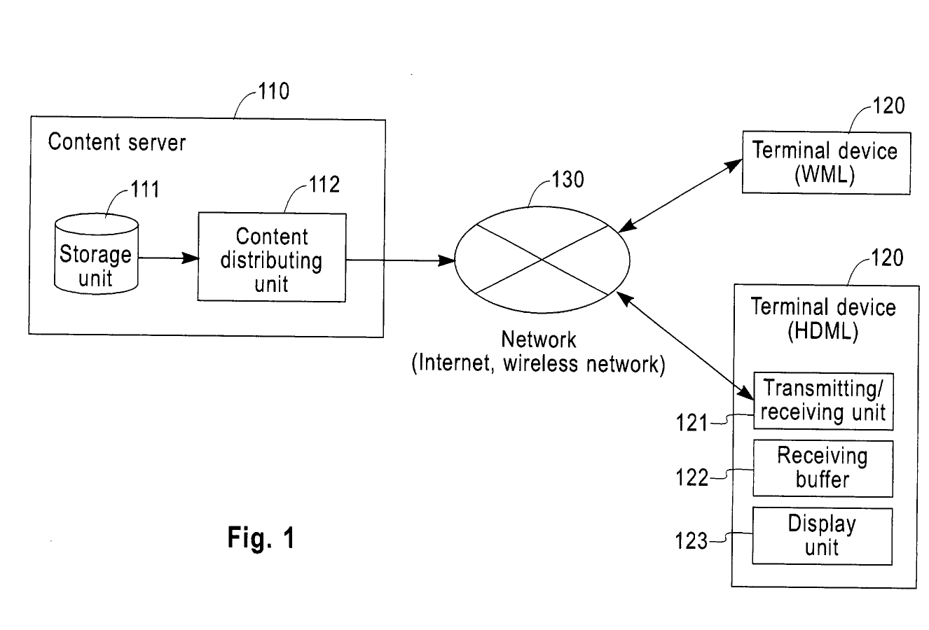

FIG. 1 is a diagram showing an example of a system configuration for implementing an embodiment of the present invention.

A network system as shown in FIG. 1 comprises a content server 110, a terminal device 120 having a browser for displaying the data described in WML or HDML, and a network (such as the Internet or wireless network) 130 that connects the content server 110 and the terminal device 120.

The content server 110 comprises a storage unit 111 for storing digital contents described in HTML or other Markup language, and a content distributing unit 112 for converting the contents read from the storage unit 111 in correspondence to the browser of the terminal device 120 and transmitting them to the terminal device 120 over a network 130. The distributed contents may be stored beforehand in the storage unit 111, or acquired from other web servers. Or a web application may be stored in the storage unit 111, and the contents may be dynamically generated based on the description of the web application. The contents have an internal representation of DOM (Document Object Model) or an abstract tree structure similar to DOM.

The terminal device 120 comprises a transmitting/receiving unit 121 for connecting to the content server 111 over the network 130, a receiving buffer 122 for temporarily storing the web contents transmitted from the content server 110, and a display unit 123 for displaying the web contents stored in the receiving buffer 122. To display the digital contents on the display unit 123, a browser supports a display screen unit called a “card” and a transmission/reception unit called a “deck”. This browser deals with markup languages such as WML and HDML, for example.

The card depends on the screen size of the display unit 123, not shown, in the terminal device 120, but because most browsers have a scroll function, the physical screen size does not have constraints on the size of card. However, since the card is directly manipulated as the user interface by a human, the way of deciding the size of card or its navigation method has some influence on its usage.

On the other hand, the deck is a transmission/reception unit of the contents between the content server 110 and the terminal device 120. Because the deck received in the terminal device 120 needs to be accumulated, the capacity of the receiving buffer 122 for the terminal device 120 limits the data size of deck. However, within the capacity of the receiving buffer 122, the increased data size of deck decreases the amount of communication between the content server 110 and the terminal device 120 and enhances the communication efficiency.

When connected to the content server 110 over the network 130, the terminal device 120 firstly transmits the device information (e.g., memory capacity of the receiving buffer 122, detailed later) from the transmitting/receiving unit 121 to the content server 110. And the terminal device 120 receives a data set (deck including a plurality of cards) generated based on the device information and displays the contents made up of cards on the display unit 123.

The operation for viewing the contents only refers to the cards within the received deck, it is handled within the receiving buffer 122 (displays the cards within the receiving buffer 122), and no transmission request for deck is issued to the content server 110. On the other hand, to gain access to the cards not residing in the received deck, a transmission request for the corresponding card is issued to the content server 110. If receiving the transmission request for the card, the content server 110 generates a new deck including the requested card and transmits it to the terminal device 120.

In an example of FIG. 1, two terminal devices 120 are connected to the network 130, but in practice, a variety of terminal devices 120 that are different in the screen size of the display unit 123 or in the memory capacity of the receiving buffer 122 are connected. Since the content server 110 cannot know in advance the capabilities of the terminal devices 120, it needs to dynamically do the operation of converting the contents according to the capability of each terminal device 120 after actually receiving the transmission request from the terminal device 120.

Accordingly, the content distributing unit 112 of the content server 110 needs to have a function of dividing the contents having a tree structure read from the storage unit 111 into cards and decks in accordance with the screen size of the display unit 123 in the terminal device 120 as the transmission destination and the memory capacity of the receiving buffer 122. This operation is required to be performed in consideration of the usability as the user interface and the communication efficiency.

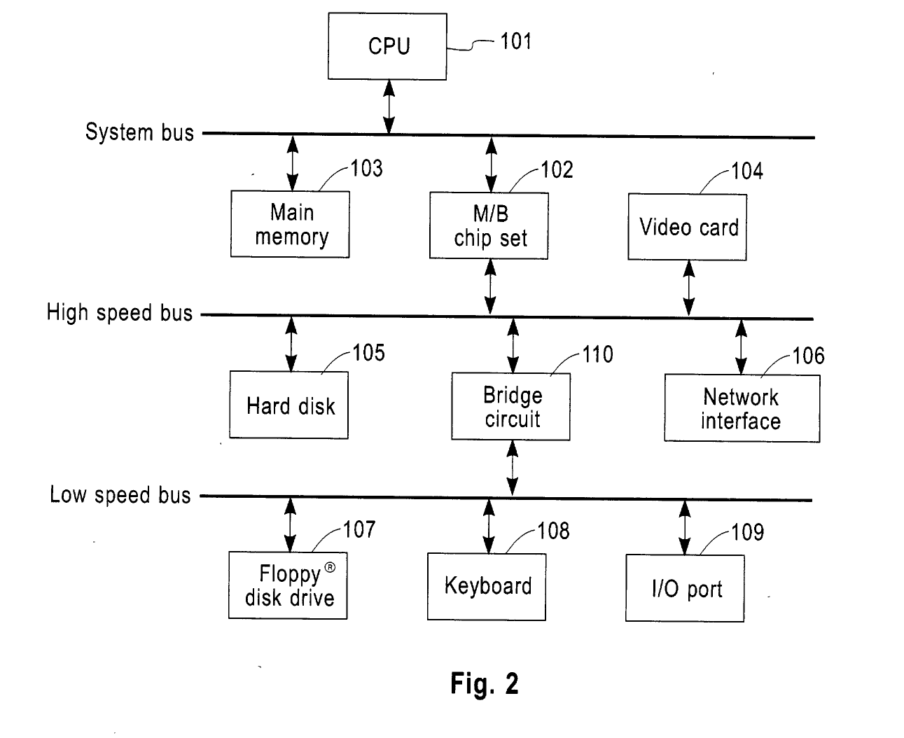

FIG. 2 is a diagram typically illustrating an example of the hardware configuration of a computer suitable for implementing the content server 110 according to the embodiment of the invention.

The computer as shown in FIG. 2 comprises a CPU (Central Processing Unit) 101, an M/B (Mother Board) chip set 102 and a main memory 103 connected via a system bus to the CPU 101, a video card 104, a hard disk 105, a network interface 106 connected via a high speed bus such as PCI bus or the like to the M/B chip set 102, and a floppy disk drive 107, a keyboard 108 and an I/O port 109 connected via a bridge circuit 110 and a low speed bus such as ISA bus to the M/B chip set 102.

The content server 110 realized in the computer as shown in FIG. 2 is connected via the network interface 106 to the network 130. Accordingly, in transmitting or receiving the data to or from the terminal device 120, the network interface 106 is transmitting/receiving means. Also, the main memory 103 or the hard disk 105 corresponds to the storage unit 111 as shown in FIG. 1.

FIG. 2 only illustrates an example of the configuration of the computer for implementing the retrieval method according to the embodiment of the invention, but various other system configurations may be conceived without departing from the sprit or scope of the invention.

In this embodiment, the content distributing unit 112 as shown in FIG. 1 can fulfill its function under the control of the CPU 101 by a program expanded in the main memory 103 as shown in FIG. 2, and the contents having a tree structure read from the hard disk 105 are divided into cards and decks in accordance with the screen size of the display unit 123 in the terminal device 120 and the memory capacity of the receiving buffer 122.

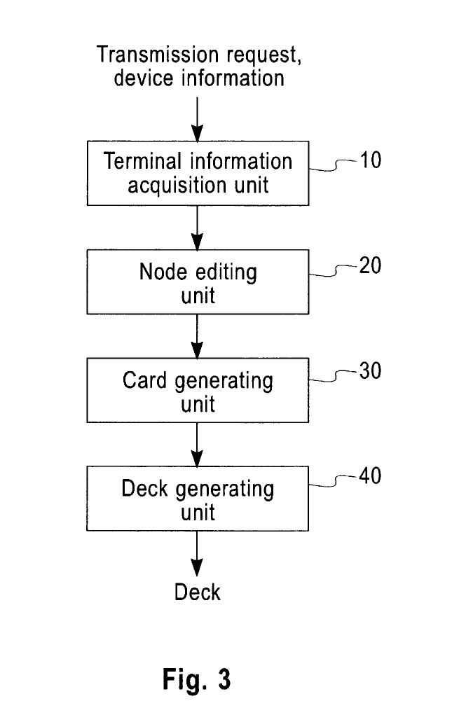

FIG. 3 is a block diagram showing an example of the functional blocks for dividing the contents according to the embodiment of the invention under the control of the CPU 101 by the program. Referring to FIG. 3, in this embodiment, the functional blocks include a terminal information acquisition unit 10 for acquiring the information regarding the capability of the terminal device 120, a node editing unit 20 for appending annotation information to each of nodes of the tree-structured contents that are read from the hard disk 105, a card generating unit 30 for dividing the tree-structured contents based on the annotation information appended to the node in the node editing unit 20 and generating the cards, and a deck generating unit 40 for gathering the cards generated in the card generating unit 30 and generating the deck.

The above components are virtual software blocks implemented under the control of the CPU 101 by the program. The program is stored in a magnetic disk, an optical disk, a semiconductor memory, or other storage media, and distributed, or transmitted over the network. In this embodiment, the program is input via the network interface 106 or the floppy disk drive 107 as shown in FIG. 2, or the CD-ROM drive, not shown, and stored in the hard disk 105. And the program stored in the hard disk 105 is read into the main memory 103 and executed by the CPU 101.

In the configuration of this embodiment as shown in FIG. 3, the terminal information acquisition unit 10 acquires the device information of each terminal device 120 (terminal device making a transmission request) that is a transmission destination of the contents. The acquired device information is stored in the main memory 103. This device information serves as the parameters for generating the cards and decks to be transmitted. Specifically, these parameters include the screen size that is the criterion to the size of units of dividing the contents, the performance of display process or communication speed that is the criterion to whether or not to divide the contents, and the size of the receiving buffer 122 that is a limit value for the size of deck.

The node editing unit 20 inputs the content as transmission object, and appends the annotation information representing the property or nature of information to be displayed to the nodes of the content having tree structure. In this annotation information, it is specified whether or not the information represented by the node is separable from the parent node. The node being unseparable from the parent node cannot be divided in this embodiment, because the information must be incorporated into the parent node. In case of the separable node, the annotation information has the property indicating how the separated information is accessed by the user. For instance, it specifies whether that part of the information is accessed selectively (random access) or is accessed sequentially (sequential access).

The annotation information can be automatically decided by the node editing unit 20 based on the type of elements constituting the contents (e.g., type of XML tag) and the capability value of device, etc. In addition, the developer may attach appropriate annotation information considering the meaning of the contents at the time of creating the contents (or designing the dynamic contents). Also, the annotation information may be altered at the time of display test of the contents to provide more suitable view. The contents having the annotation appended to the node are stored in the main memory 103. The details of the annotation information will be given later.

The card generating unit 30 reads the digital contents having the annotation information appended by the node editing unit 20 from the main memory 103, and divides them into cards. At this time, the node having the annotation of random access is generated as the menu card to include the link to the child node. If the child node also has the annotation of random access, the menu cards are recursively generated. Consequently, a set of nodes of random access takes the form of a hierarchical menu as a whole. In case of the node having the annotation of sequential access, all of the single display units at its descendant nodes are arranged to preserve the original sequence. Thereafter, the contents are divided into cards of an appropriate size, which are linked to be sequentially accessed. In case of the sequential access nodes, an outline card to include the links to the separated cards may be created as needed.

In either case of the random access or the sequential access, all the unseparable child nodes are embedded into the card of the parent node. Consequently, a set of cards having a tree structure consisting of a hierarchical menu with the cards to be randomly accessed and a series of card groups to be sequentially accessed are generated. This tree of cards is not exactly same as the tree structure of original contents, because the operation of gathering unseparable nodes into one card has been performed, as described above, but its structure reflects the original contents to some extent. A distinction of whether each card is accessed randomly or sequentially can be decided according to the node converted into the card. The details of the carding algorithm for the contents will be described later.

When there is a request for a specific card from the terminal device 120 (it is assumed that the root card for the tree of cards is requested for the first request for the contents), the deck generating unit 40 gathers appropriate cards, and generates the deck to return it to the terminal device 120 making the request.

Herein, the deck is generated in the following manner. That is, first of all, the cards on the path from the root card to the requested card are added to the deck (e.g., they are obtained by following the link of “return” or “backward”), and further the descendant cards from the requested card are added to the deck in breadth-first searching manner. However, in the case where the requested card is the sequential access card, the card to be accessed next to the requested card (e.g., it obtained by following the link of “next”) is firstly added to the deck.

If there is a more margin in the data size of deck (limit capacity) based on the memory capacity of the receiving buffer 122 in the terminal device 120, the same process is repeated for the parent card to be added to the deck. The cards are added to the deck till the sum of data size of each card (number of bytes) reaches the limit capacity of one deck, whereby the deck is decided for the request from the terminal device 120. The details of the deck generating algorithm will be described later.

The annotation information appended to each node for the contents by the node editing unit 20 will be described below. In this embodiment, the annotations appended to the node is composed of the following information.

Information indicating whether or not the node is separable as the card from the parent node.

Method of presenting the information described in the node (for the separable node). Namely, information indicating how the user makes access to the information (randomly or sequentially).

Unit of division. Specifically, information specifying the number of pieces of information (number of nodes in the tree for the contents) contained in the divided cards.

The properties or natures of the contents to which the annotation of “random access” is appended are listed as below:

1. Access to all the information is not necessarily required.

2. The user chooses and displays an arbitrary part (card).

3. Display order of plural parts (cards) is arbitrary.

4. There is high possibility of moving up or down the tree.

In contrast, the properties or natures of the contents to which the annotation of “sequential access” is appended are listed as below:

1. Access to all the information should be done.

2. The access order is given.

3. The retrieval or jump to an arbitrary part is not made in most cases.

4. There is high possibility of moving to the sibling nodes in the tree (accessing order).

These annotations may be appended in advance by the programmer in view of the meaning of the contents, based on the guideline as cited above, or automatically appended by a heuristic method, using the information as to the structure or tag of contents. Furthermore, the programmer may modify a part of the annotations appended automatically.

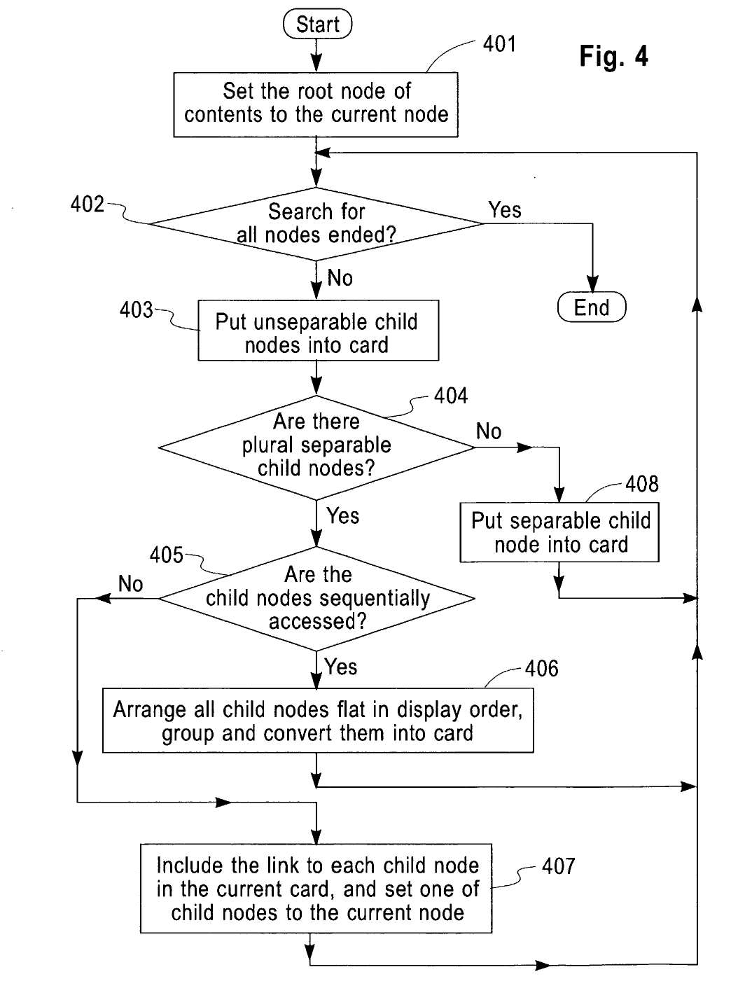

The carding algorithm for the contents that is made by the card generating unit 30 will be described below. FIG. 4 is a flowchart for explaining an example of a procedure for dividing the contents of tree structure into cards. Referring to FIG. 4, this algorithm is recursively performed from the root node of the tree of contents. First of all, the root node of contents read from the main memory 103 is given as the current node to do search operation for the nodes (process for the subsequent steps 403 to 408) (step 401). This is the recursive operation, so the carding algorithm is ended if all the nodes have been searched in the subsequent process (step 402).

In searching for the node, first of all, the self node and the child nodes unseparable are put into the substance of a card to be created (current card) (step 403). If there are not a sufficient number of separable child nodes to be separated (e.g., separation would be meaningless if there is no separable child or only one separable child), all the information is incorporated into one current card. And because there is no need of searching for the node at the lower level, the procedure returns to searching for another node (steps 404, 408).

In the case where there are a sufficient number of separable child nodes, it is determined, based on the annotation, whether the child node is random access type or sequential access type (step 405). If the child node is sequentially accessed, all the child nodes are arranged flat in the display order. And the child nodes are grouped based on the criterion for the data size of card and the information amount of each node, so that the information amount contained in each card may be equalized, and converted into a series of cards. Each generated card has the link to the next card. For the series of cards to be sequentially accessed, the current card is regarded as the card indicating the outline of the row of cards, and the link to each card is generated. Alternatively, instead of creating the outline card, the link directly connected to the first card in the row can be made from other cards (step 406).

On the other hand, if there are plenty of separable child nodes which are randomly accessed, the link to each child node is contained in the current card as a menu, and then any one of the child nodes is set as a new current node (step 407). Then, returning to step 402, it is determined whether or not all the nodes have been searched, and the carding algorithm following step 403 is recursively applied to the separated node. In the above manner, the tree of cards is generated.

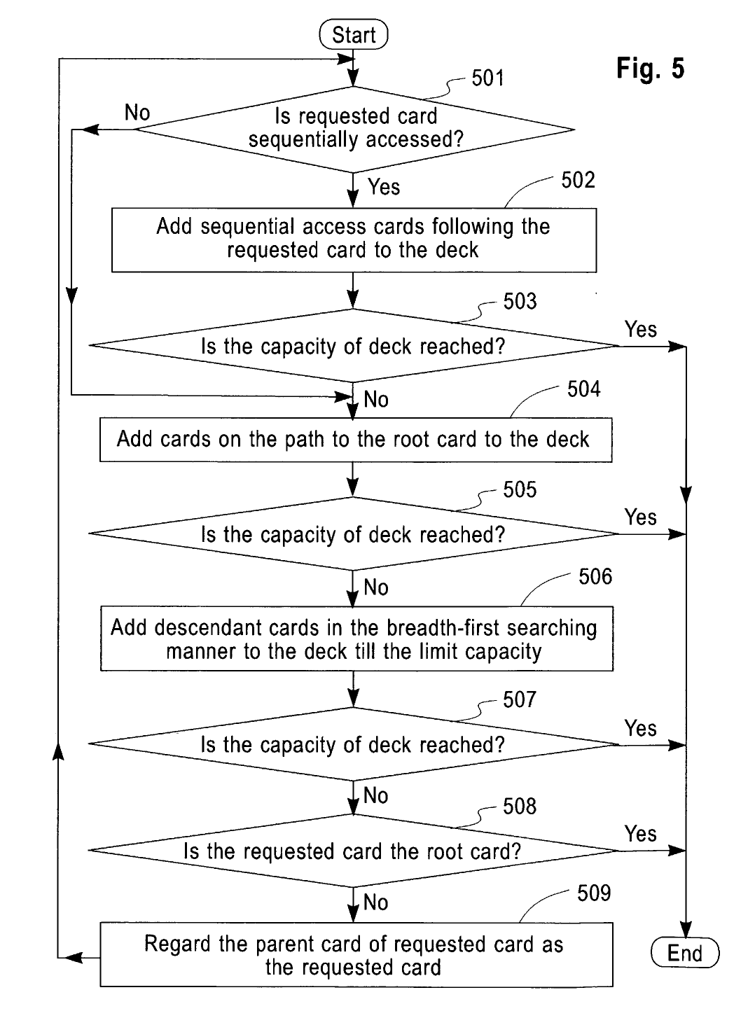

A deck generating algorithm of the deck generating unit 40 will be described below. FIG. 5 is a flowchart for explaining a procedure for generating a deck by gathering cards generated in FIG. 4. Referring to FIG. 5, first of all, a requested card is read from the main memory 103, and it is determined whether or not the requested card is a sequential access card (step 501). In case of the sequential access card, all the cards to be accessed sequentially within the limit capacity of deck are read from the main memory 103 in accordance with the order (reference order) of information within the card, and added to the deck (step 502). At this time, if the limit capacity of deck is reached, the deck generating process is ended (step 503).

If it is determined that the card requested at step 501 is a random access card, or if it is determined that the requested card is the sequential access card and the limit capacity of the deck is not reached even though all the cards to be accessed sequentially are added to the deck, the cards on the path going back from the requested card to the root card are read from the main memory 103, and added to the deck (step 504). At this time, if the limit capacity of deck is reached, the deck generating process is ended (step 505).

If the limit capacity of deck is not reached after cards are added to the deck at step 504, the descendant cards of the requested card are further read in the breadth-first searching manner (i.e., in the priority of cards located on the shallower layer in the tree of cards) from the main memory 103, and added to the deck (steps 505 and 506). At this time, if the limit capacity of deck is reached, the deck generating process is ended (step 507).

If the limit capacity of deck is not reached after cards are added to the deck at step 506, the parent card of the requested card is regarded as a new requested card, and the process following step 501 is repeated in succession till the root card appears (steps 507, 508 and 509).

In case of generating the cards in accordance with the algorithm as shown in FIG. 4, unseparable nodes are gathered into one card, and the data size of one card may exceed the memory capacity of the receiving buffer 122 in the terminal device 120 requesting the card. In this case, it is required to divide the card so that the data size may be within the memory capacity of the receiving buffer 122.

In the deck generating process as shown in FIG. 5, if the data size of the card firstly selected at step 502 or 504 (i.e., requested from the terminal device 120) exceeds the memory capacity of the receiving buffer 122 in the terminal device 120, it is required to divide the card. This card cannot be divided in accordance with the embodiment of the invention, and is divided by other rule. More specifically, the existing method can be taken in which the card is simply divided based on the number of characters, regarding the substance of the card as the simple text.

In the above way, the tree-structured contents are divided into cards and decks. In case of transforming the contents in accordance with the capability of the terminal device 120 as transmission destination of the contents (based on the device information) in the above manner, the processings of selecting only the necessary information, changing the presentation order of the information, and grouping the relevant information (especially gathering undividable information into one) may be made. The change result can be represented as the tree of contents. For example, the selection of information can be made by deleting the link to the child node. Also, the presentation order of information can be represented by the order of child node. Furthermore, the undividable information can be represented by unifying the information into one node. The transformation process is performed after the terminal information acquisition unit 10 accepts the device information of the terminal device 120, and before dividing into cards. In view of involving the transformation of undividable information, the transformation process may be performed after the node editing unit 20 appends the annotations to the node.

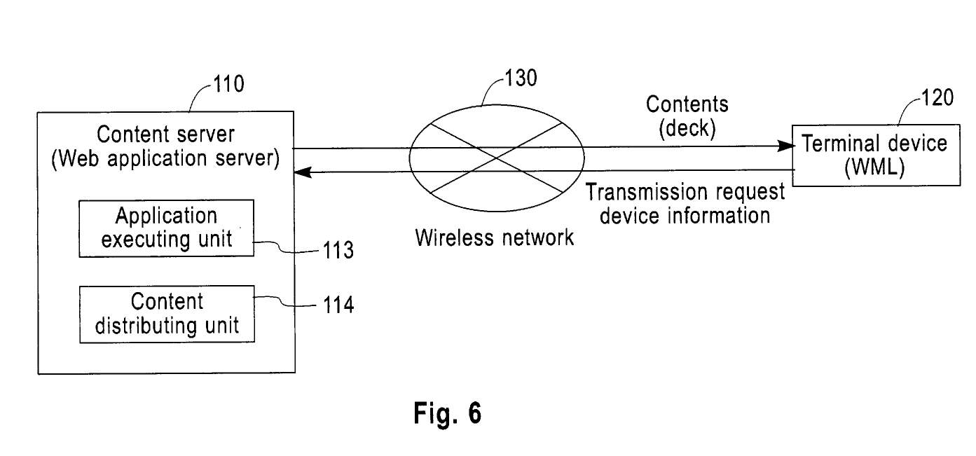

An application example in which this embodiment of the invention is applied to a specific network system will be presented. FIG. 6 is a diagram showing a configuration example of the network system to which the embodiment of the invention is applied. In the network system as shown in FIG. 6, the content server (web application server) 110 comprises an application execution unit 113 for executing a web application described in XML, and a contents distributing unit 114 for distributing the contents dynamically generated by executing the web application through the wireless network 130 to the terminal device 120. The function of the contents distributing unit 114 is the same as that of the contents distributing unit 112 for the content server 110 as shown in FIG. 1 and described with reference to FIG. 3.

The transmission of the contents between the content server 110 and the terminal device 120 is made in accordance with the WAP (Wireless Application Protocol), and the terminal device 120 displays the cards of contents in the browser coping with the WML.

Upon connecting to the content server 110, the terminal device 120 notifies the device information such as the screen size and the size of receiving buffer 122 to the content server 110, using a description method such as the CC/PP (W3C: Composite Capabilities/Preference Profiles: Requirements and Architecture (Working Draft)).

In this application example, the web application is considered to make the product information retrieval and product introduction for the computer related equipment. The product information retrieved using some retrieval methods is classified for each category and displayed.

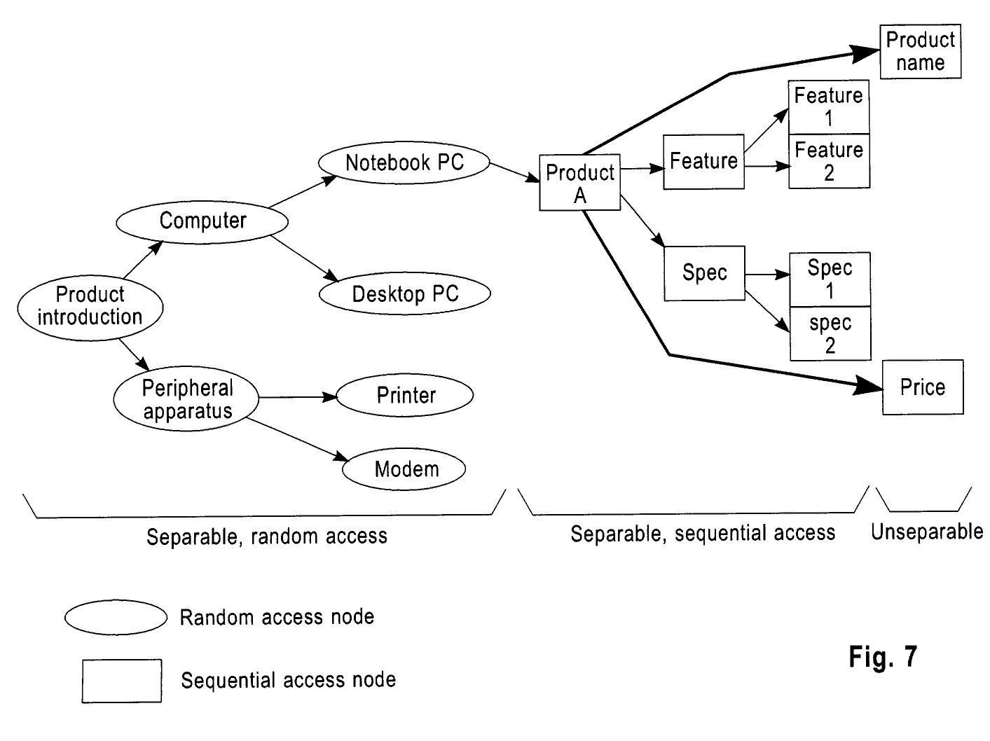

FIG. 7 is a diagram illustrating an example of the tree-structured content with the annotation information appended to its node to present the retrieval result in the product retrieval by the web application. The contents as shown in FIG. 7 are browsed by selecting the information regarding specific one product based on the category. In FIG. 7, the node of product introduction is branched into two categories of computer product and peripheral apparatus product. Moreover, the computer product is branched into the notebook type personal computer (denoted as “notebook PC” in the figure) and the desktop type personal computer (denotes as “desktop PC”). Herein, the node is the data element for the user to select an appropriate category and make navigation, in which each node is separable, and can have the annotation of random access, as shown in FIG. 7.

The node of product A under the notebook type personal computer has the annotation of sequential access appended as the substance to enable the user to gain access to all the information. The node of product A is composed of the product name, feature, and detailed information such as specification (“spec”), but the product name and the price have the annotation of unseparable because they are basic and always required information.

These annotations can be embedded as additional information into the web application described in XML. For instance, they can be written as the attribute information of tag.

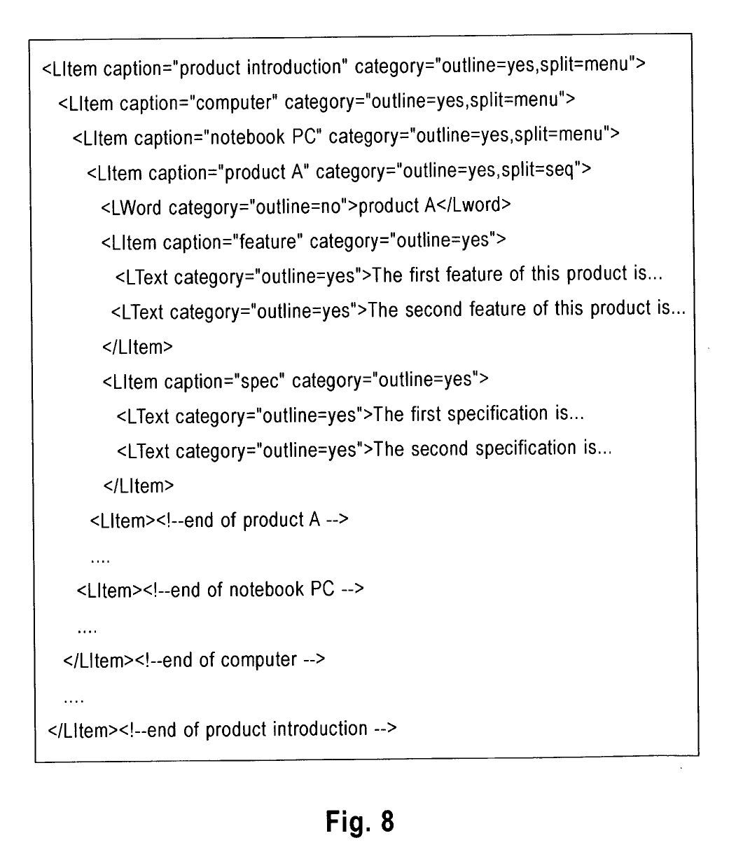

FIG. 8 is a diagram showing an example of XML document having annotations as additional information embedded. In FIG. 8, “LItem” is a tag for representing the information having the structure. “LWord” and “LText” are tags representing the actual character information, and employed to describe the word and the sentence. In the attribute of each tag, “caption” specifies the heading of information, and is employed as the heading of each screen or the title of link when the contents are actually converted into WML.

In FIG. 8, the “category” attribute describes the annotations for use to make division into cards and decks. The value of “category” is written by marking off the substance of each annotation by a comma. The attribute has the form of:

outline=.., split=..

representing separable for “outline=yes”, or unseparable for “outline=no”. Also, “split=menu” indicates the random access node, and “split=seq” indicates the sequential access node.

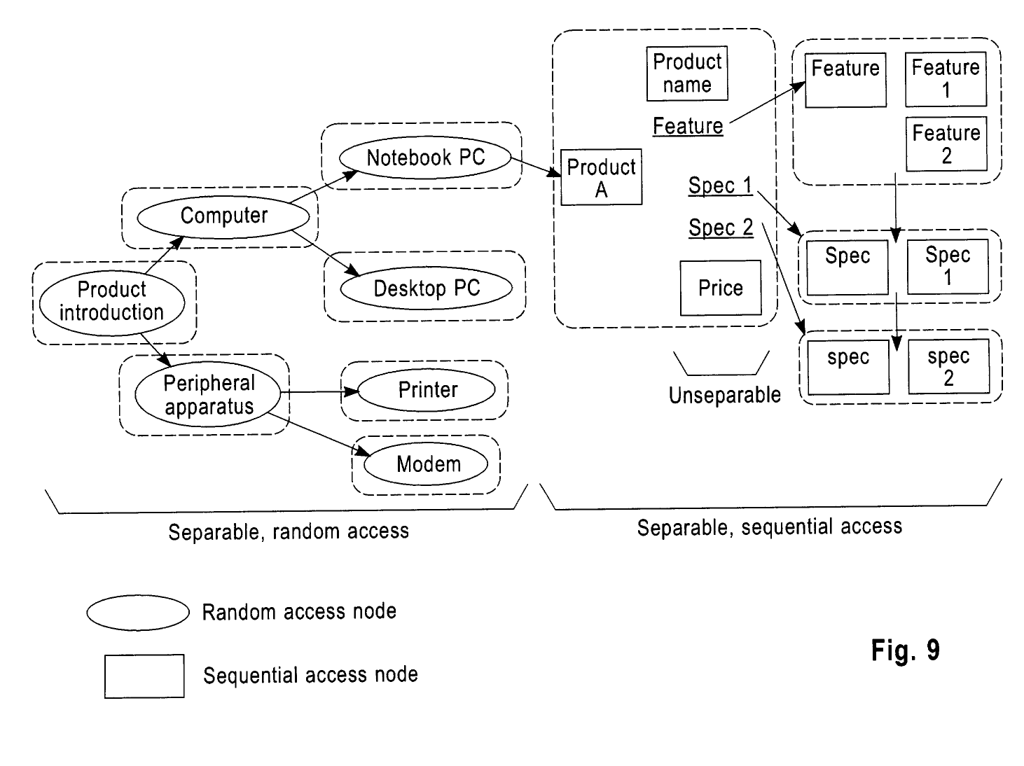

FIG. 9 is a diagram illustrating an application example of the carding algorithm of the card generating unit 30 of FIG. 4 to the contents of FIG. 7, based on the above annotations. In FIG. 9, the rectangle surrounded by the broken line is one card. As seen from FIG. 9, each node is one card at the random access node. Accordingly, the user browsing this card on the terminal device 120 can get the aimed information by following the link based on the category of product.

On the other hand, at the node of product A that is the node of sequential access, the product name, the feature, the feature 1, the feature 2, the spec, the spec 1, the spec 2, and the price that are the nodes under the node of product A are arranged flat. However, since the product name and the price are unseparable (outline=no), they are directly incorporated into the outline card. Also, the feature 1 and the feature 2 have relatively small amount of information, and are combined into one card. The spec 1 and the spec 2 have large amount of information, and each provided as one card. These cards are linked (as indicated by the arrow in the figure) to be accessed in succession. Also, the separated card is linked from the outline card of product A.

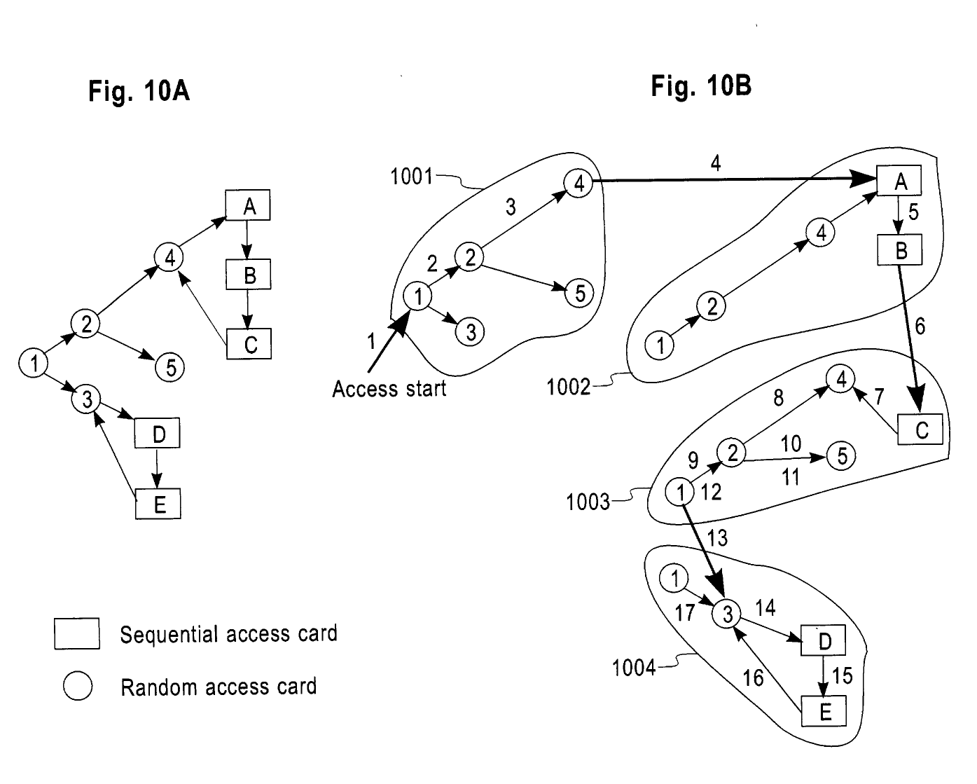

FIG. 10 is a diagram illustrating an application example of a deck generating algorithm of the deck generating unit 40 of FIG. 5 to the carded contents of FIG. 9. In FIG. 10, the node numbered with a circle is the product category card (random access), and the node numbered with a square is the product information card (sequential access).

The card tree as shown in FIG. 10A is followed with the category to sequentially access the cards of product information A, B and C, and then returning to the root card, to access another cards of product information D and E, in which FIG. 10B illustrates how to divide the deck. In this process, a total of four decks are generated, and transmitted from the content server 110 to the terminal device 120.

More specifically, the user of the terminal device 120 makes a transmission request for the deck containing the card “1” to firstly gain access to the card “1”. In response to the transmission request, the content server 110 creates a deck 1001 including the cards “1” to “5” and transmits the deck 1001 to the terminal device 120.

If receiving the deck 1001, the terminal device 120 stores it in the receiving buffer 122, and displays the card “1” to be accessed on the display unit 123. The user of the terminal device 120 follows the card “2”, “4” within the deck 1001, and gains access to the next card “A”. Since the card “A” is not contained in the deck 1001, the terminal device 120 makes a transmission request for the deck containing the card “A” to the content server 110. In response to this transmission request, the content server 110 creates a deck 1002 including the cards “1”, “2”, “4”, “A” and “B”, and transmits it to the terminal device 120.

If receiving the deck 1002, the terminal device 120 annuls the deck 1001, stores the newly received deck 1002 in the receiving buffer 122, and displays the card “A” to be accessed on the display unit 123. The user of the terminal device 120 browses the card “B” within the deck 1002, and then gains access to the card “C”. Since the card “C” is not contained in the deck 1002, the terminal device 120 makes a transmission request for the deck containing the card “C” to the content server 110. In response to this transmission request, the content server 110 creates a deck 1003 including the cards “1”, “2”, “4”, “5” and “C”, and transmits it to the terminal device 120.

Likewise, the terminal device 120 stores the deck 1003 in the receiving buffer 122, and displays the card “C” on the display unit 123. Thereafter, the user browsed each of the cards contained in the deck 1003, and further gains access to the card “3”. Since the card “3” is not contained in the deck 1003, the content server 110 creates a deck 1004 including the cards “1”, “3”, “D” and “E”. The user of the terminal device 120 browses the cards “D” and “E” in the deck 1004.

Herein, it is assumed that the data size of one deck can be up to five cards from the capacity limit of the receiving buffer 122 based on the device information transmitted from the terminal device 120.

The editing tools useful when the developer appends the annotations to the node of the contents will be described below. To edit the annotations appended to the node, a tool (software) with which the user can edit while viewing the result screen is employed. This tool, which is integrated with the content server 110 as an object computer of web application, switches the display between an execution screen of web application and an edit screen of the contents with GUI on the display unit, not shown, to execute the web application or to edit the contents.

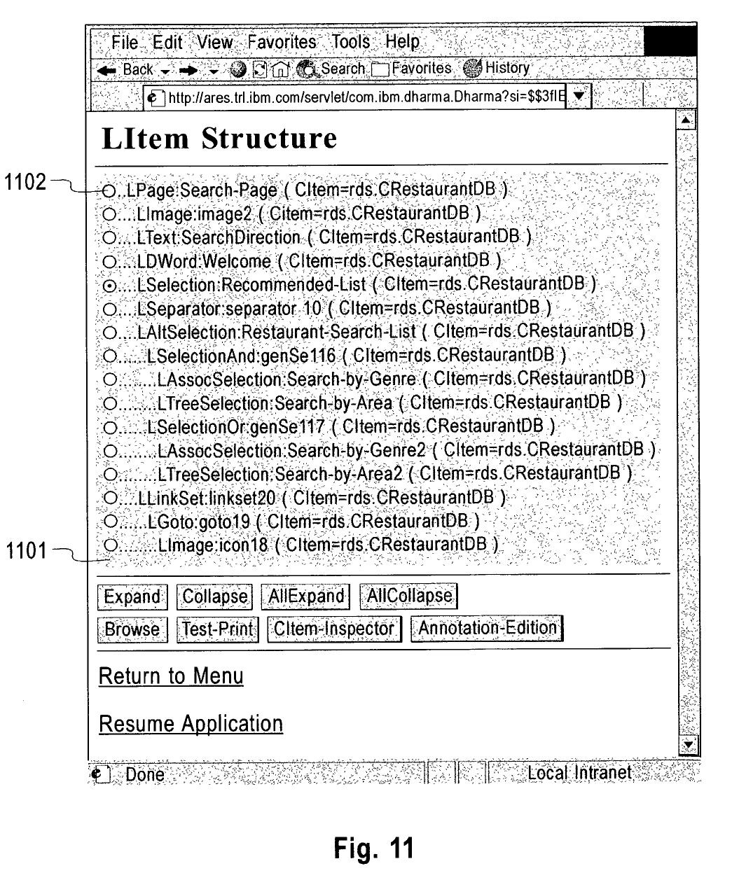

FIG. 11 is a view showing an edit screen of the contents as a display example the screen for deciding the node to which the annotation is appended. On the edit screen as shown in FIG. 11, a tree 1101 of the contents to be edited is displayed, and the node with annotations can be selected. That is, a radio button 1102 is provided at the left end of each node (corresponding to each line), whereby the user can select arbitrary node to append the annotations.

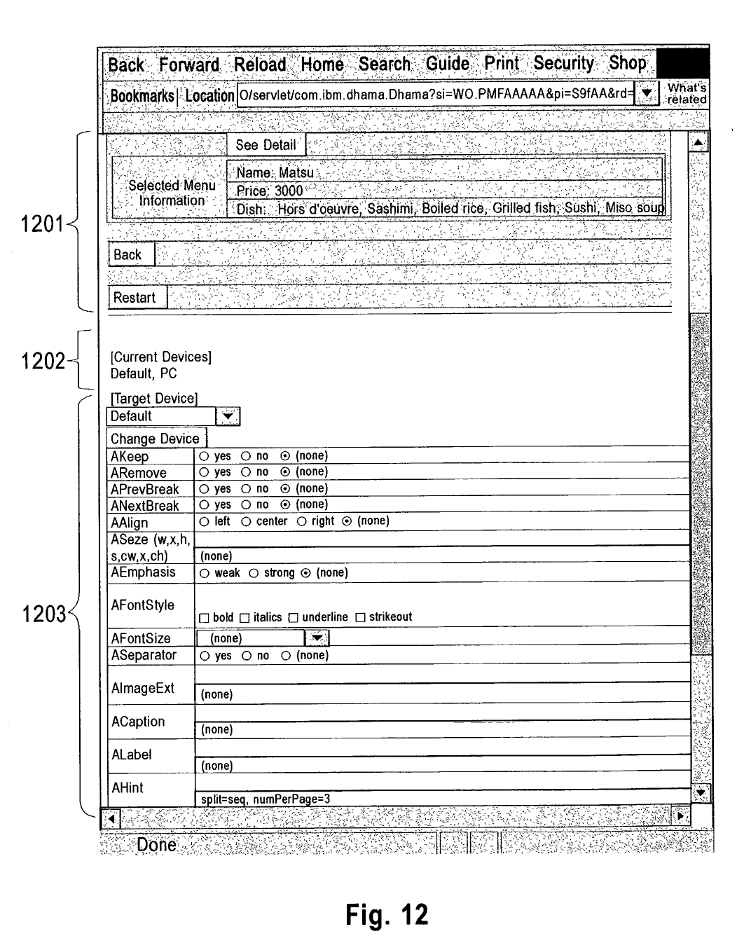

If the node to append the annotation is decided, the screen for appending the annotations appears. FIG. 12 is a view showing the edit screen of the contents as a display example of the screen for appending the annotations to a desired node. The edit screen of FIG. 12 is composed of a preview area 1201 of the node, a display/selection area 1202 of the target device, and a display/input area 1203 of the annotations. The annotations of dividable or information providing method can be specified by writing the character string outline=yes or split=menu preset for the tag in the column of annotation name “AHint” in the display/input area 1203.

If the annotations are appended to the node the above manner, the contents are stored in the storage unit 111 such as memory or hard disk in the content server 110, and thereafter read by the card generating unit 30 in response to a request from the terminal device 120, whereby the annotations appended to the node are employed in the dividing process.

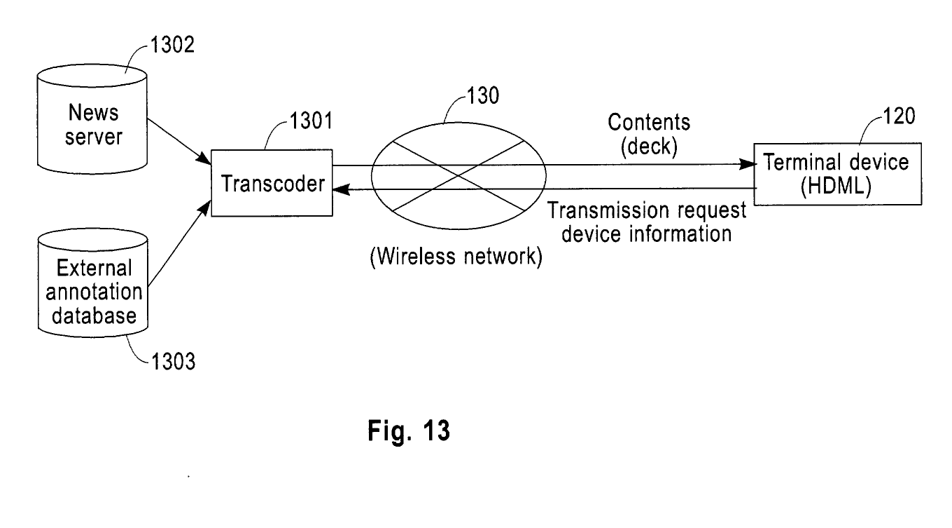

FIG. 13 is a block diagram showing another configuration example of a network system to which this embodiment of the invention is applied. The network system as shown in FIG. 13 has a converter (transcoder) 1301 for converting the news contents described in HTML into the terminal device 120 having the HDML browser, as a server corresponding to the content server 110. The HTML has a fixed format, and can not append the annotations arbitrarily unlike XML. Thus, an external annotation that is associated with the node by pointing to a desired location of the HTML document describing the news contents is employed in this example. The transcoder 1301 reads the news contents from a news server 1302, acquires the external annotations corresponding to the HTML document of the news contents from an external annotation database 1303, and converts the news contents into HDML, based on this external annotations, for transmission to the terminal device 120.

The news server 1302 storing the news contents and the external annotation database 1303 storing the external annotations may constitute one server along with the transcoder 1301, or provided on the network 130, apart from the transcoder 1301.

The news contents stored in the news server 1302 are classified into categories of politics, economy, society, and entertainment, which are random access nodes. Each article consists of a title, a subtitle, a lead, and a text, which are all sequentially accessed.

These news contents are described in HTML, and the transcoder 1301 can convert the news contents into the tree (DOM tree), employing an appropriate HTML parser. By providing the external annotations for this DOM tree, the node of the DOM tree can have the annotation information appended. The external annotations are made to be associated with the node by pointing to a desired location in the HTML document of the news contents, for example using XPath (W3C: XML Path Language (XPath) Version 1.0, HYPERLINK http://www.w3.org/Style/XSL/). These external annotations are stored in advance in the external annotation database 1303, and employed to convert the contents in response to the request from the terminal device 120.

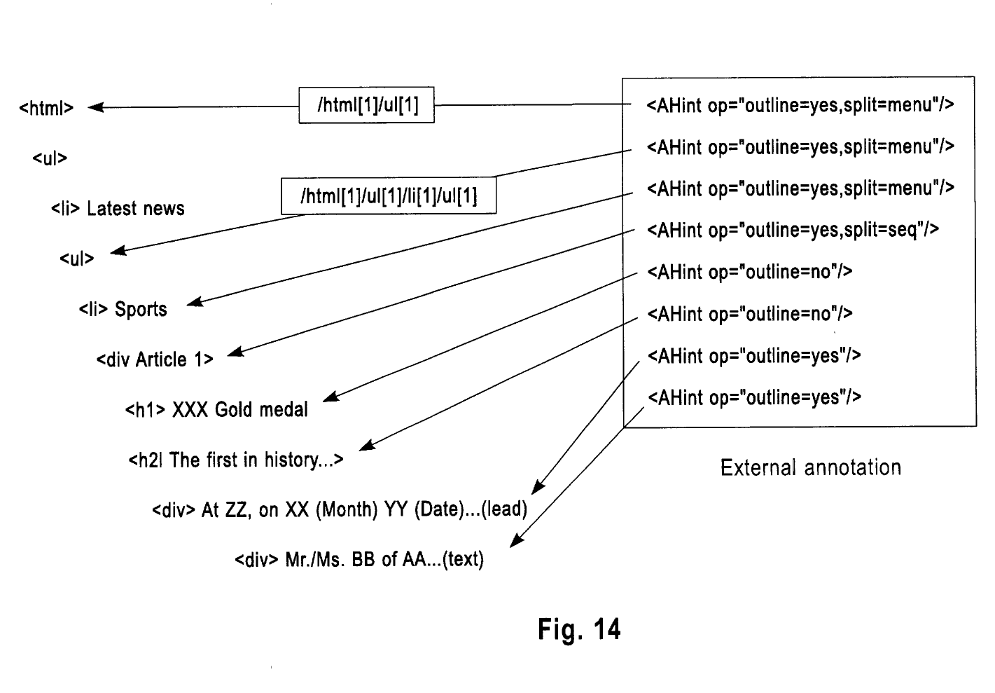

FIG. 14 is a diagram showing how to append the annotations to the news contents described in HTML. The original news contents as shown in FIG. 14 has the external annotations appended as illustrated in the figure. In this example, the external annotation is also described in XML, and represented by the tag “AHint” as the annotation for division into cards and decks. The substance of annotation is described with the attribute value “op.” The substance of description is similar to that in the example of FIG. 8. Which HTML element each annotation (<AHint>) points to is described by XPath. In FIG. 14, XPath is indicated by the arrow from right to left, and XPath expressions for first two annotations are given as the actual representation example.

Among the nodes as shown in FIG. 14, “latest news” and “sports” are random access (split=menu) nodes. On one hand, “article 1” is a sequential access (split=seq) node. The headline and subtitle denoted by the tags “h1” and “h2” are elements of article 1, and unseparable (outline=no) elements. On the other hand, the lead and text of article are separable (outline=yes).

These annotations may be described manually by the developer of the transcoder 1301, using an annotations language as shown in FIG. 14, or automatically described by the heuristic method. In the example of FIG. 14, the annotations can be automatically appended by making the rules of separable and random access for “ul” tag, separable and sequential access for “div” tag, and unseparable for “h1” and “h2” tags. Moreover, the automatically appended annotations may be rewritten partially by the developer of the transcoder 1301 and optimized.

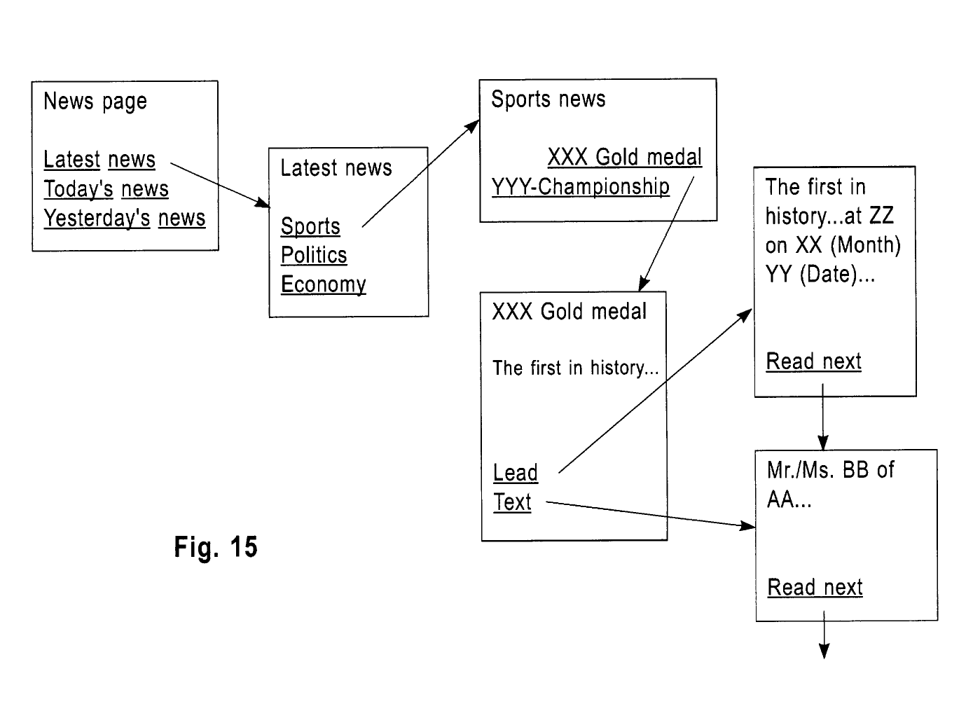

FIG. 15 is a diagram illustrating an example of the contents in which the XML document of FIG. 14 is carded. Referring to FIG. 15, the card of news page contains the choices of “today's news” and “yesterday's news,” in addition to the “latest news.” Also, the card of “latest news” contains the choices of “politics” and “economy,” in addition to the “sports.” The card having the substance of FIG. 14 is selected by following the choices in sequence.

In the two application examples as above, the contents described in XML or HTML are converted into WML or HDML, and distributed. However, the algorithm for converting the contents into cards in this embodiment can be also applied to the page division used in transmitting the contents to the terminal device coping with the language without the concept of deck. For example, this algorithm can be applied to the division of HTML page or the GUI program described in Java operating on the terminal, when the tree-structured contents are processed. More specifically, this embodiment can be applied to a front end application developing model that enables predetermined contents to cope with a plurality of different execution environments.

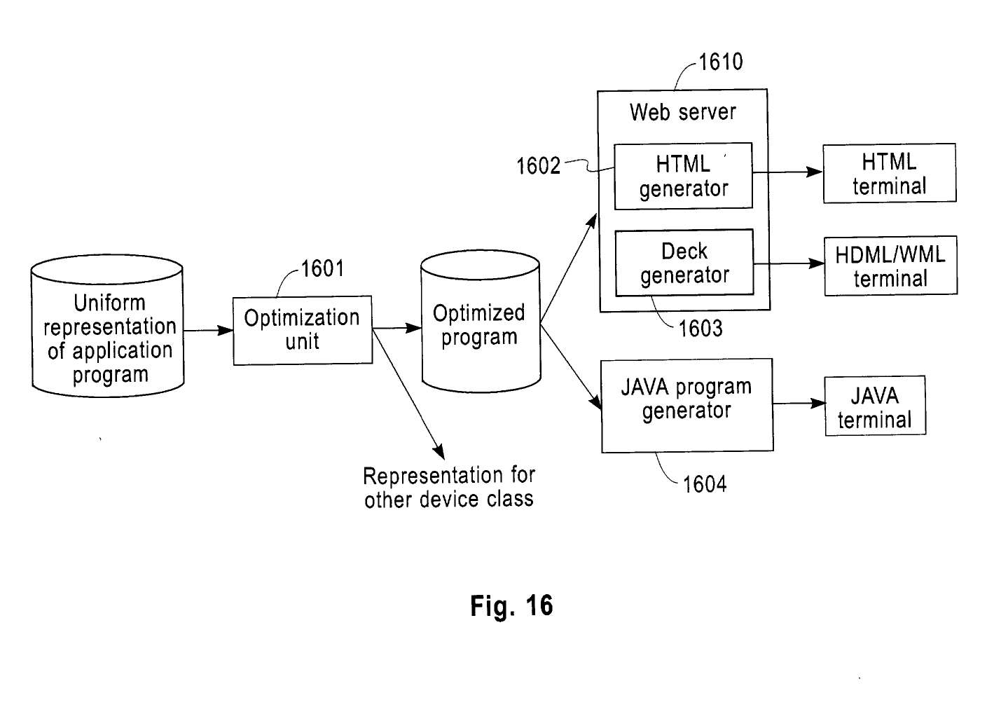

FIG. 16 is a diagram showing a configuration example of the front end application developing model. The developing model of FIG. 16 comprises an optimization unit 1601 for optimizing an application program written in uniform format into a predetermined device class, and conversion means for converting the application program optimized by the optimization unit 1601 into the format (or terminal program code) suitable for the execution environment. The conversion means in FIG. 16 comprises an HTML generator 1602 for generating the contents described in HTML, a deck generator 1603 for generating the contents composed of cards and decks corresponding to the WML or HDML, and a Java program generator 1604 for generating the Java program.

The uniform representation of application program is given by the tree structure such as DOM tree, and not dependent upon the type of the terminal device 120 or the environment. This application program itself is produced using some application developing tools. The physical representation format of application program may be a tag representation using the XML, or its own application description language, or a typical file storing format (Serialized objects) for Java object. Moreover, this application program contains the annotations useful for card division, using the same representation format.

The optimization unit 1601 reads an application program in uniform representation from the memory, and makes screen division so that the screen may be displayed optimally in the preset device class. Herein, the carding algorithm of FIG. 4 is employed. The device class is the class of the terminal device 120 using this application program that is classified into several kinds of class, based on classification factors such as screen size. For instance, there are a compact screen class having the very small screen such as the cellular phone, a small screen class having the small screen but effective for the portable terminal, a television screen class having the large screen, and a large screen class having the very large screen. The optimization criteria can be set up freely in accordance with the standard or specification of the terminal device 120 for distributing the application program, such as the resolution of the display unit 123 or communication speed, as well as the screen size of the display unit 123.

The optimized application program is temporarily stored in the memory to be shared among a plurality of execution environments. The representation format at this time is the same as the uniform representation.

In the case where this application program is displayed on the terminal device 120 such as personal computer having the HTML browser, the application program is converted, employing the HTML generator 1602 operating on the web server 1610. That is, the HTML generator 1602 reads the optimized application program stored in the memory, generates the HTML document corresponding to the application program, and transmits it to the terminal device 120 such as personal computer having the HTML browser.

Also, in the case where this application program is displayed on the terminal device 120 having the WML or HDML browser, the application program is converted, employing the deck generator 1603 operating on the web server 1610. In this case, it is converted after the deck is generated because there is a concept of deck in the WML or HDML. At this time, the deck is generated based on the capacity limit of the receiving buffer 122 acquired from each terminal device 120.

Further, the program operating on the terminal device 120 can be generated, using the same optimized program representation. The Java program generator 1604 reads the optimized application program representation from the memory, and generates the Java program operating on the terminal device 120. The generated Java program can be downloaded into the terminal device 120 having the Java VM (Virtual Machine), and executed.

As described above, the present invention makes it possible to generates the cards that are easily used by the user of the user agents, based on the conditions of the user agents or the substance of the contents, when the tree-structured contents are divided into cards and decks and transmitted.

Also, this invention makes it possible to constitute the decks dynamically by selecting a set of optimal cards so that the data size of one deck may be within the limit capacity (number of bytes) of the receiving buffer in the user agents, and the number of retransmitting decks may be reduced, when transmitting the contents.

What is claimed is:

1. A system for converting digital content for distribution to a terminal, the system comprising:
a receiving unit for receiving a transmission request for the digital content from the terminal; and
a card generating unit for dividing the digital content into a plurality of cards, which are units for displaying the digital content on the terminal, based on annotation information appended to each data element in the digital content.

2. The system according to claim 1, wherein the digital content has a tree structure in which said each data element is treated as a node.

3. The system according to claim 2, wherein said annotation information includes information for indicating if said each data element as the node is separable from a parent node, and said card generating unit divides the content into said plurality of cards so that all the unseparable nodes are embedded into a card of their parent node.

4. The system according to claim 2, wherein said annotation information includes information for specifying if said each data element as the node is a random access node or a sequential access node.

5. The system according to claim 4, wherein said card generating unit divides the digital content into a set of cards having a tree structure comprising a hierarchical menu of random access nodes to be accessed randomly and a series of card groups to be accessed sequentially.

6. The system according to claim 1, wherein said receiving unit further receives memory information on a memory capacity of a buffer in the terminal for storing the digital content, the system further comprising:
a deck generating unit for generating a deck, which is a unit for transmitting the digital content, by collecting a requested card including at least a data element requested by the terminal and a card linked to or from the requested card based on a predetermined rule, so that a transmission data size is within said memory capacity.

7. The system according to claim 6, wherein, if the requested card is a card to be accessed sequentially, said deck generating unit generates the deck by collecting a series of cards to be accessed sequentially including the requested card.

8. The system according to claim 6, wherein, if the requested card is a card to be accessed randomly, said deck generating unit generates the deck by collecting, in addition to the requested card, at least one card on a path going from the requested card to a root card in the digital content.

9. The system according to claim 8, wherein, if the requested card is a card to be accessed randomly and the memory capacity of the buffer is not reached, said deck generating unit further collects descendant cards of the requested card in a breadth-first searching manner.

10. A method for converting digital content for distribution to a terminal, the method comprising the steps of :
receiving a transmission request for the digital content from the terminal; and
dividing the digital content into a plurality of cards, which are units for displaying the digital content on the terminal, based on annotation information appended to each data element in the digital content.

11. The method according to claim 10, wherein the digital content has a tree structure in which said each data element is treated as a node.

12. The method according to claim 11, wherein said annotation information includes information for indicating if said each data element as the node is separable from a parent node, and said dividing step divides the content into said plurality of cards so that all the unseparable nodes are embedded into a card of their parent node.

13. The method according to claim 11, wherein said annotation information includes information for specifying if said each data element as the node is a random access node or a sequential access node.

14. The method according to claim 13, wherein said dividing step divides the digital content into a set of cards having a tree structure comprising a hierarchical menu of random access nodes to be accessed randomly and a series of card groups to be accessed sequentially.

15. The method according to claim 10, wherein said receiving step further receives memory information on a memory capacity of a buffer in the terminal for storing the digital content, the method further comprising the step of:
generating a deck, which is a unit for transmitting the digital content, by collecting a requested card including at least a data element requested by the terminal and a card linked to or from the requested card based on a predetermined rule, so that a transmission data size is within said memory capacity .

16. The method according to claim 15, wherein, if the requested card is a card to be accessed sequentially, said generating step generates the deck by collecting a series of cards to be accessed sequentially including the requested card.

17. The method according to claim 15, wherein, if the requested card is a card to be accessed randomly, said generating step generates the deck by collecting, in addition to the requested card, at least one card on a path going from the requested card to a root card in the digital content.

18. The method according to claim 17, wherein, if the requested card is a card to be accessed randomly and the memory capacity of the buffer is not reached, said generating step further collects descendant cards of the requested card in a breadth-first searching manner.
